(19) United States
(12) Patent Application Publication
(10) Pub. No.: US 2020/0402489 A1
(43) Pub. Date: Dec. 24, 2020

(54) INFORMATION PROCESSING APPARATUS, INFORMATION PROCESSING METHOD, AND PROGRAM

(71) Applicant: SONY CORPORATION, Tokyo (JP)

(72) Inventors: Junichirou SAKATA, Tokyo (JP); Keisuke SAITOU, Kanagawa (JP); Keiichiro YAMADA, Tokyo (JP); Misao SATO, Kanagawa (JP); Kouichi SUNAGA, Tokyo (JP); Takuya OGURA, Tokyo (JP)

(73) Assignee: SONY CORPORATION, Tokyo (JP)

(21) Appl. No.: 16/764,676

(22) PCT Filed: Oct. 10, 2018
(86) PCT No.: PCT/JP2018/037635

§ 371 Date: May 15, 2020

(30) Foreign Application Priority Data
Nov. 24, 2017 (JP) 2017-225539

(51) Int. Cl. G10H 1/00; G06F 16/635; G06F 16/68; G06F 16/64

(52) U.S. Cl. CPC G10H 1/0058; G06F 16/635; G10H 2240/175; G06F 16/64; G10H 2240/141; G06F 16/686

(57) ABSTRACT

Provided is a mechanism allowing improvement of the degree of freedom in production when multiple users collaboratively produce a music track via a network. An information processing apparatus includes a control unit configured to receive multitrack data containing multiple pieces of track data generated by different users, edit the multitrack data, and transmit the edited multitrack data.

### FIELD

The present disclosure relates to an information processing apparatus, an information processing method, and a program.

### BACKGROUND

In recent years, production environment and listening environment for contents, specifically music contents (hereinafter also referred to as a music track), have greatly developed. For example, even a general user merely installs dedicated software in a smartphone so that the music track production environment can be easily created. Thus, enjoyment of music track production has increasingly developed. For this reason, development of the technique of supporting such user's music track production has been demanded.

For example, Patent Literature 1 below discloses the technique of controlling, when a music track remix is produced by combination of multiple sound materials, the reproduction position, reproduction timing, tempo, etc. of each sound material to produce a music track with a high degree of completion.

### CITATION LIST

### Patent Literature

Patent Literature 1: JP-A-2008-164932

### SUMMARY

### Technical Problem

The technique described in Patent Literature 1 above is the technique of locally controlling the music track by a single user. Meanwhile, in recent years, collaborative (i.e., conjoint or cooperative) production of a music track via a network by multiple users has been available in association with a higher network transmission speed and a greater online storage capacity, and a technique for such production has been demanded.

As one example, there is the technique of downloading, by a user, sound data uploaded to a server by other users, synthesizing the downloaded sound data and newly-recorded sound data into a single piece of sound data, and uploading such data. According to this technique, the multiple users can produce a music track via a network while sequentially overwriting the sound data. However, in this technique, the sound data is kept overwritten, and for this reason, rollback etc. cannot be performed. Thus, the degree of freedom in music track production is low.

For these reasons, the present disclosure provides a mechanism allowing improvement of the degree of freedom in production when multiple users collaboratively produce a music track via a network.

### Solution to Problem

According to the present disclosure, an information processing apparatus is provided that includes: a control unit configured to receive multitrack data containing multiple pieces of track data generated by different users, edit the multitrack data, and transmit the edited multitrack data.

Moreover, according to the present disclosure, an information processing apparatus is provided that includes: a control unit configured to transmit multitrack data containing multiple pieces of track data generated by different users and stored in a storage apparatus to a terminal apparatus configured to edit the multitrack data, receive the edited multitrack data from the terminal apparatus, and update the multitrack data stored in the storage apparatus by the edited multitrack data.

Moreover, according to the present disclosure, an information processing method executed by a processor is provided that includes: receiving multitrack data containing multiple pieces of track data generated by different users; editing the multitrack data; and transmitting the edited multitrack data.

Moreover, according to the present disclosure, a program is provided that causes a computer to function as a control unit configured to receive multitrack data containing multiple pieces of track data generated by different users, edit the multitrack data, and transmit the edited multitrack data.

### Advantageous Effects of Invention

As described above, according to the present disclosure, the mechanism allowing improvement of the degree of freedom in production when the multiple users collaboratively produce the music track via the network is provided. Note that the above-described advantageous effect is not limited. In addition to or instead of the above-described advantageous effect, any of advantageous effects described in the present specification or other advantageous effects which can be grasped from the present specification may be provided.

### BRIEF DESCRIPTION OF DRAWINGS

FIG. 1 is a view illustrating one example of the configuration of a system according to the present embodiment.

FIG. 2 is a block diagram illustrating one example of a hardware configuration of a terminal apparatus according to the present embodiment.

FIG. 3 is a block diagram illustrating one example of a logical functional configuration of the terminal apparatus according to the present embodiment.

FIG. 4 is a block diagram illustrating one example of a hardware configuration of a server according to the present embodiment.

FIG. 5 is a block diagram illustrating one example of a logical functional configuration of the server according to the present embodiment.

FIG. 6 is a diagram illustrating a relationship between multitrack data and track data according to the present embodiment.

FIG. 7 is a diagram illustrating a relationship between a group and a user according to the present embodiment.

FIG. 8 is a diagram for describing one example of a relationship among various types of metadata according to the present embodiment.

FIG. 9 is a view illustrating one example of an UI displayed on the terminal apparatus according to the present embodiment.

FIG. 10 is a view illustrating one example of the UI displayed on the terminal apparatus according to the present embodiment.

FIG. 11 is a view illustrating one example of the UI displayed on the terminal apparatus according to the present embodiment.

FIG. 12 is a view illustrating one example of the UI displayed on the terminal apparatus according to the present embodiment.

FIG. 13 is a sequence diagram illustrating one example of the flow of music track production processing executed in the system according to the present embodiment.

FIG. 14 is a sequence diagram illustrating one example of the flow of editing support processing executed in the system according to the present embodiment.

### DESCRIPTION OF EMBODIMENTS

Hereinafter, a preferred embodiment of the present disclosure will be described in detail with reference to the attached drawings. Note that in the present specification and the drawings, the same reference numerals are used to represent components having the substantially same functional configurations, and overlapping description thereof will be omitted.

Note that description will be made in the following order.

1. Introduction

1.1. Definition of Terms

1.2. Technical Problems

2. Configuration Examples

2.1. Entire Configuration Example

2.2. Configuration Example of Terminal Apparatus 10

2.3. Configuration Example of Server 20

3. Technical Features

3.1. Data Structure

3.2. Editing of Multitrack Data

3.3 UI

3.4. Editing Support

3.5. Flow of Processing

4. Summary

### 1. INTRODUCTION

### 1.1. Definition of Terms

Track data is data corresponding to one recording/reproduction mechanism of multiple recording/reproduction mechanisms operating in parallel. More specifically, the track data is sound data which is handled in the process of producing the contents of a music track created by musical performance with multiple musical instruments, singing voices, etc. and which is obtained by separate recording of each musical instrument or singing voice. The track data contains the sound data (an analog signal or a digital signal) and information indicating, e.g., an effect applied to the sound data. Hereinafter, the track data will be merely referred to as a track in some cases.

Multitrack data is data corresponding to the assembly of multiple tracks in the multiple recording/reproduction mechanisms operating in parallel. The multitrack data contains multiple pieces of track data. For example, the multitrack data contains the track data obtained by recording of a vocal, the track data obtained by recording of a guitar, and the track data obtained by recording of a drum, and forms a single music track. Hereinafter, the multitrack data will be also referred to as a music track in some cases.

Mix (also referred to as mixing) is the process of adjusting the settings of the multiple tracks contained in the multitrack data. For example, by a mix process, e.g., the sound volume and tone of each track are adjusted. The multiple tracks contained in the multitrack data are superimposed on each other through the mix process, and in this manner, are finished as the single music track.

### 1.2. Technical Problems

Recent production and listening environment for the music track have greatly developed in association with a higher network transmission speed and a greater online storage capacity.

First, the listening environment will be described. In recent years, an online service by a media player has become commonplace, and enormous music tracks are managed on a network. For this reason, a user can listen these music tracks by various devices owned by the user oneself. On the other hand, an effort for searching out the music tracks matching user's preference from the enormous music tracks on the online by the user has been enormous. For reducing such an effort, a management side of the online service categorizes the music tracks from various perspectives, and provides attribute data indicating these categories to the music tracks. In this manner, the management side of the online service provides a service for recommending the music tracks matching user's preference.

Subsequently, the production environment will be described. In recent years, music peripherals, particularly mobile devices such as smartphones and tablet devices, have rapidly become PC-less (personal computer less). Accordingly, completion of a series of music track production from recording of musical instrument performance to simulation of performance data (i.e., the track data) on the mobile device has becoming available without the need for preparing typical expensive equipment.

Considering such convenience in music track production and network affinity of the mobile device, it is desirable to easily collaboratively produce the music track via the network by multiple users. For these reasons, in the present disclosure, a mechanism allowing music track production by means of the multitrack data containing the multiple pieces of track data produced by different users is provided.

Moreover, in the present disclosure, a mechanism allowing utilization of the track data produced by other users as a resource for music track production is provided in such a manner that the track data recorded by each mobile device is pooled and managed on the network and is shared with the other users. Further, in the present disclosure, a mechanism for efficiently searching the track data to be utilized as the resource for music track production is provided. This is because a certain user needs an enormous effort for searching out the track data mixable (compatible) with the track data of the user oneself from the enormous tracks pooled on the network.

### 2. CONFIGURATION EXAMPLES

### 2.1. Entire Configuration Example

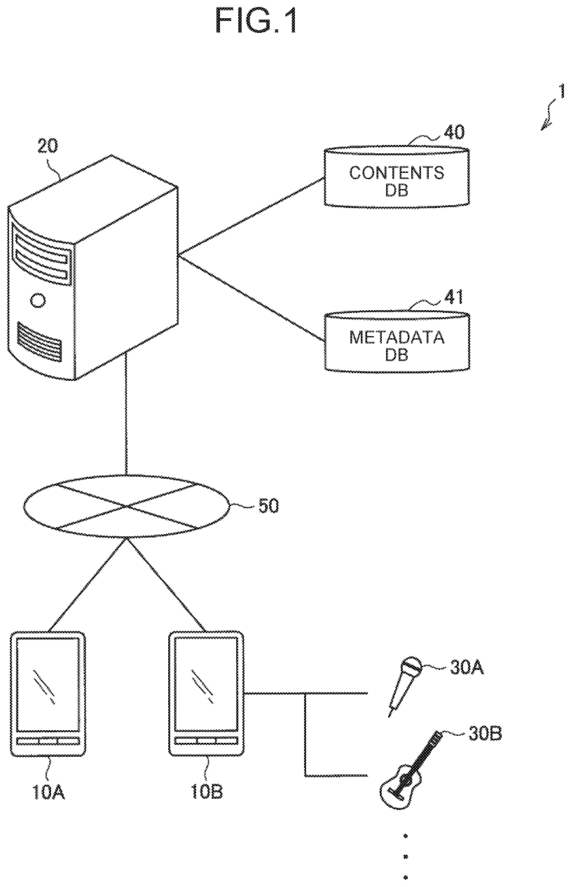

FIG. 1 is a view illustrating one example of the configuration of a system 1 according to the present embodiment. As illustrated in FIG. 1, the system 1 includes a terminal apparatus 10 (10A and 10B), a server 20, recording equipment 30 (30A and 30B), a contents DB (Data Base) 40, and a metadata DB 41. Moreover, the terminal apparatus 10 and the server 20 are connected to each other via a network 50.

The terminal apparatus 10 is an apparatus used by a user (a music track producer) of the terminal apparatus 10 and configured to perform music track production (in other words, music track editing) based on user operation. The terminal apparatus 10 includes, for example, a PC, a dedicated terminal, or a mobile device such as a smartphone or a tablet device. As illustrated in FIG. 1, the system 1 may include multiple terminal apparatuses 10. The terminal apparatuses 10 are each used by the different users. The multiple users can collaboratively produce the music track via the terminal apparatuses 10 used by these users and the server 20. Moreover, the multiple users can also create a group based on a common purpose such as collaborative music track production. Each user produces (e.g., generates) the track data, and adds such data to the multitrack data.

The server 20 is an apparatus for providing a service for supporting music track production. While managing the contents DB 40 and the metadata DB 41, the server 20 provides the service for supporting music track production. For example, the server 20 transmits data stored in these DBs to the terminal apparatus 10, and stores data edited by the terminal apparatus 10 in the DBs. Moreover, the server 20 performs, based on the data stored in these DBs, processing for supporting music track editing in the terminal apparatus 10. Note that FIG. 1 illustrates an example where the server 20, the contents DB 40, and the metadata DB 41 are separately configured, but the present technique is not limited to such an example. For example, the contents DB 40 and the metadata DB 41 may be configured as a single DB, or the server 20 may include the contents DB 40 and the metadata DB 41. Alternatively, multiple servers including a server for controlling the contents DB 40 and a server for controlling the metadata DB 41 may cooperate with each other.

The recording equipment 30 is an apparatus configured to record voice or performance of the user to generate an audio signal. The recording equipment 30 includes, for example, an audio device such as a microphone or a music instrument, and an amplifier and an effector for processing the recorded audio signal. The recording equipment 30 is connected to the terminal apparatus 10, and outputs the generated audio signal to the terminal apparatus 10. The recording equipment 30 is connected to the terminal apparatus 10 by an optional connection method such as an USB (Universal Serial Bus), Lightening (the registered trademark), Wi-Fi (the registered trademark), Bluetooth (the registered trademark), or an analog audio cable.

The contents DB 40 and the metadata DB 41 are storage apparatuses configured to store information regarding the multitrack data. Particularly, the contents DB 40 is an apparatus configured to store and manage contents. The contents DB 40 stores the track data and the multitrack data. Moreover, the metadata DB 41 is an apparatus configured to store and manage metadata regarding the contents. The metadata DB 41 stores the metadata regarding the user, the group, the track data, and the multitrack data. The metadata described herein is a data group (i.e., an attribute data group) including an attribute name and attribute data, and is information indicating characteristics of a target (e.g., the track data).

The network 50 is a wired or wireless transmission path for information transmitted from an apparatus connected to the network 50. The network 50 includes, for example, a cellular communication network, a LAN (Local Area Network), a wireless LAN, a phone line, or the Internet.

### 2.2. Configuration Example of Terminal Apparatus 10

(1) Hardware Configuration

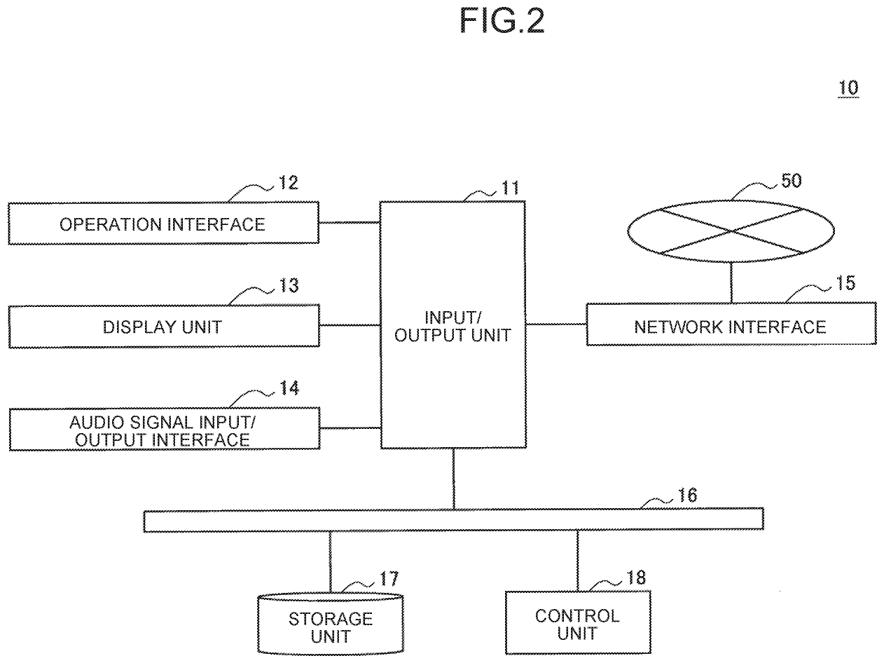

FIG. 2 is a block diagram illustrating one example of a hardware configuration of the terminal apparatus 10 according to the present embodiment. Information processing by the terminal apparatus 10 according to the present embodiment is implemented by cooperation of software and hardware described below.

As illustrated in FIG. 2, the terminal apparatus 10 according to the present embodiment includes an input/output unit 11, an operation interface 12, a display unit 13, an audio signal input/output interface 14, a network interface 15, a bus 16, a storage unit 17, and a control unit 18.

The input/output unit 11 is an apparatus configured to perform input of information to the terminal apparatus 10 and output of information from the terminal apparatus 10. Specifically, the input/output unit 11 performs input/output of information via the operation interface 12, the display unit 13, the audio signal input/output interface 14, and the network interface 15.

The operation interface 12 is an interface for receiving the user operation. The operation interface 12 is implemented by an apparatus to which information is input by the user, such as a mouse, a keyboard, a touch panel, a button, a microphone, a switch, or a lever. Alternatively, the operation interface 12 may be, for example, a remote control apparatus utilizing infrared light or other radio waves. Typically, the operation interface 12 is, as a touch panel display, configured integrally with the display unit 13.

The display unit 13 is an apparatus configured to display information. The display unit 13 is implemented by a display apparatus such as a CRT display apparatus, a liquid crystal display apparatus, a plasma display apparatus, an EL display apparatus, a laser projector, an LED projector, or a lamp. The display unit 13 visually displays results obtained by various types of processing by the terminal apparatus 10 in various forms such as a text, an image, a table, and a graph.

The audio signal input/output interface 14 is an interface for receiving the input of the audio signal and outputting the audio signal. The audio signal input/output interface 14 is connected to the recording equipment 30, and receives the input of the audio signal output from the recording equipment 30. Moreover, the audio signal input/output interface 14 receives the input of an audio signal in an Inter-App Audio format, the audio signal being output from an application operating inside the terminal apparatus 10. Alternatively, the audio signal input/output interface 14 may include a voice output apparatus such as a speaker or headphones, and converts the audio signal into an analog signal to aurally output information.

The network interface 15 is an interface for performing transmission or reception of information via the network 50. The network interface 15 is, for example, a wired LAN, a wireless LAN, a cellular communication network, Bluetooth (the registered trademark), or a communication card for WUSB (Wireless USB). Alternatively, the network interface 15 may be, for example, a router for optical communication, a router for an ADSL (Asymmetric Digital Subscriber Line), or various communication modems. For example, the network interface 15 can perform, according to a predetermined protocol such as TCP/IP, transmission/reception of a signal etc. among the network interface 15 and the Internet or other types of communication equipment.

The bus 16 is a circuit for connecting various types of hardware in the terminal apparatus 10 to allow intercommunication thereof. By the bus 16, the input/output unit 11, the storage unit 17, and the control unit 18 are connected to each other.

The storage unit 17 is an apparatus for data storage. The storage unit 17 is, for example, implemented by a magnetic storage unit device such as an HDD, a semiconductor storage device, an optical storage device, or a magnetic optical storage device. The storage unit 17 may include, for example, a storage medium, a recording apparatus configured to record data in the storage medium, a reading apparatus configured to read the data from the storage medium, and a deletion apparatus configured to delete the data stored in the storage medium. The storage unit 17 stores, for example, an OS (Operating System), an application program, and various types of data to be executed by the control unit 18 and various types of data acquired from the outside.

The control unit 18 functions as an arithmetic processing apparatus and a control apparatus, and controls general operation in the terminal apparatus 10 according to various programs. The control unit 18 may be implemented by various processors such as a CPU (Central Processing Unit) and an MPU (Micro Processing unit). Alternatively, in addition to or instead of the processor, the control unit 18 may be implemented by a circuit such as an integrated circuit, a DSP (digital signal processor), or an ASIC (Application Specific Integrated Circuit). The control unit 18 may further include a ROM (Read Only Memory) and a RAM (Random Access Memory). The ROM stores, for example, a program and an arithmetic parameter to be used by the control unit 18. The RAM temporarily stores, for example, a program to be used in execution of the control unit 18 and a parameter changeable as necessary in such execution.

(2) Functional Configuration

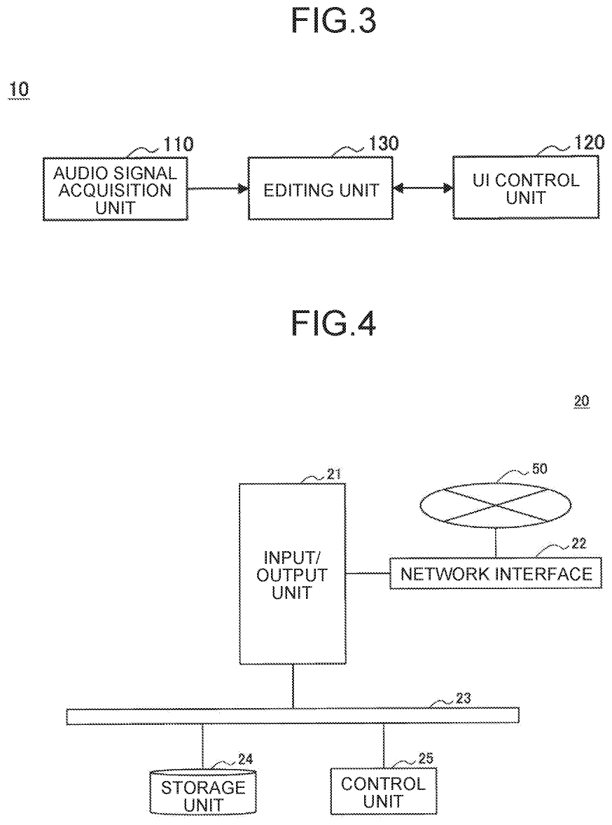

FIG. 3 is a block diagram illustrating one example of a logical functional configuration of the terminal apparatus 10 according to the present embodiment. As illustrated in FIG. 3, the terminal apparatus 10 according to the present embodiment includes an audio signal acquisition unit 110, an UI control unit 120, and an editing unit 130. The functions of these components are implemented by the hardware described above with reference to FIG. 2.

The audio signal acquisition unit 110 has the function of acquiring the audio signal. For example, the audio signal acquisition unit 110 may acquire the audio signal from the recording equipment 30 connected to the terminal apparatus 10. The audio signal acquisition unit 110 may acquire the audio signal in the Inter-App Audio format, the audio signal being output from the application operating inside the terminal apparatus 10. The audio signal acquisition unit 110 may import the audio signal stored in the terminal apparatus 10 to acquire the audio signal. The audio signal acquisition unit 110 outputs the acquired audio signal to the editing unit 130.

The UI control unit 120 generates a screen (UI) to receive operation for the UI. The UI control unit 120 generates and outputs the UI for implementing editing of the multitrack data. Then, the UI control unit 120 receives the user operation to output operation information to the editing unit 130.

The editing unit 130 performs editing of the multitrack data based on the user operation. The editing unit 130 adds, as the track data, the audio signal acquired by the audio signal acquisition unit 110 to the multitrack data, deletes the existing track data from the multitrack data, or applies the effect to the track data. The editing unit 130 may newly generate the multitrack data, or may receive, as an editing target, the multitrack data from the server 20. The editing unit 130 transmits the edited multitrack data to the server 20.

### 2.3. Configuration Example of Server 20

(1) Hardware Configuration

FIG. 4 is a block diagram illustrating one example of a hardware configuration of the server 20 according to the present embodiment. Information processing by the server 20 according to the present embodiment is implemented by cooperation of software and hardware described below.

As illustrated in FIG. 4, the server 20 according to the present embodiment includes an input/output unit 21, a network interface 22, a bus 23, a storage unit 24, and a control unit 25.

The input/output unit 21 is an apparatus configured to perform input of information to the server 20 and output of information from the server 20. Specifically, the input/output unit 21 performs input/output of information via the network interface 22.

The network interface 22 is an interface for performing transmission or reception of information via the network 50. The network interface 22 is, for example, a wired LAN, a wireless LAN, a cellular communication network, Bluetooth (the registered trademark), or a communication card for WUSB (Wireless USB). Alternatively, the network interface 22 may be, for example, a router for optical communication, a router for an ADSL (Asymmetric Digital Subscriber Line), or various communication modems. The network interface 22 can perform, according to a predetermined protocol such as TCP/IP, transmission/reception of a signal etc. among the network interface 22 and the Internet or other types of communication equipment.

The bus 23 is a circuit for connecting various types of hardware in the server 20 to allow intercommunication thereof. By the bus 23, the input/output unit 21, the storage unit 24, and the control unit 25 are connected to each other.

The storage unit 24 is an apparatus for data storage. The storage unit 24 is, for example, implemented by a magnetic storage unit device such as an HDD, a semiconductor storage device, an optical storage device, or a magnetic optical storage device. The storage unit 24 may include, for example, a storage medium, a recording apparatus configured to record data in the storage medium, a reading apparatus configured to read the data from the storage medium, and a deletion apparatus configured to delete the data stored in the storage medium. The storage unit 24 stores, for example, a program and various data to be executed by the control unit 25 and various types of data acquired from the outside.

The control unit 25 functions as an arithmetic processing apparatus and a control apparatus, and controls general operation in the server 20 according to various programs. The control unit 25 may be implemented by various processors such as a CPU (Central Processing Unit) and an MPU (Micro Processing unit). Alternatively, in addition to or instead of the processor, the control unit 25 may be implemented by a circuit such as an integrated circuit, a DSP (digital signal processor), or an ASIC (Application Specific Integrated Circuit). The control unit 25 may further include a ROM (Read Only Memory) and a RAM (Random Access Memory). The ROM stores, for example, a program and an arithmetic parameter to be used by the control unit 25. The RAM temporarily stores, for example, a program to be used in execution of the control unit 25 and a parameter changeable as necessary in such execution.

(2) Functional Configuration

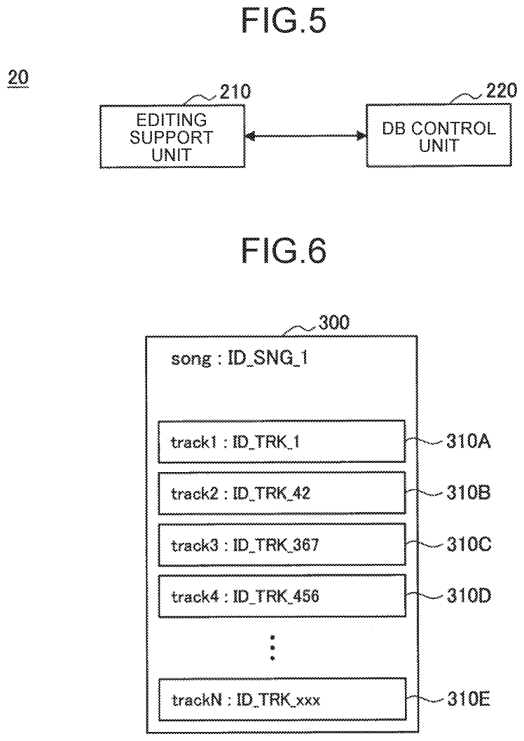

FIG. 5 is a block diagram illustrating one example of a logical functional configuration of the server 20 according to the present embodiment. As illustrated in FIG. 5, the server 20 according to the present embodiment includes an editing support unit 210 and a DB control unit 220. The functions of these components are implemented by the hardware described above with reference to FIG. 4.

The editing support unit 210 has the function of supporting the processing of editing the multitrack data by the server 20. For example, the editing support unit 210 provides an SNS for promoting interaction among the users using the terminal apparatuses 10, performs matching among the users, or searches, from the contents DB 40, the track data to be added to the multitrack data which is being edited in the terminal apparatus 10 to transmit such data to the terminal apparatus 10.

The DB control unit 220 has the function of managing the contents DB 40 and the metadata DB 41. For example, the DB control unit 220 transmits the multitrack data stored in the contents DB 40 to the terminal apparatus 10, and in the contents DB 40, stores the multitrack data received from the terminal apparatus 10. At this point, the server 20 may compare the multitrack data before and after editing to extract an editing history, and in the metadata DB 41, may store such an editing history as the metadata regarding the user. Moreover, the DB control unit 220 analyzes the multitrack data and the track data to generate the metadata, and stores such metadata in the metadata DB 41.

### 3. TECHNICAL FEATURES

### 3.1. Data Structure

(1) Multitrack Data

FIG. 6 is a diagram illustrating a relationship between the multitrack data and the track data according to the present embodiment. FIG. 6 illustrates multitrack data 300 to which identification information “ID_SNG_1” is assigned and track data 310 (310A to 310E) contained in the multitrack data 300. A character string of “ID_TRK_” and a number assigned to each piece of track data 310 and coupled to each other is identification information on each piece of track data 310. Each piece of track data 310 corresponds to performance data for each musical instrument or vocal performance data. The multitrack data 300 holds the track data 310 corresponding to all pieces of musical instrument performance data and vocal performance data forming the music track. Audio data output by mixing of these pieces of track data 310 is music track data.

Note that the multitrack data and the track data are managed in the contents DB 40. Moreover, the metadata regarding the multitrack data and the track data is managed as music track-related metadata and track-related metadata in the metadata DB 41.

(2) Metadata

The metadata managed in the metadata DB 41 will be described. The metadata managed in the metadata DB 41 includes the music track-related metadata, the track-related metadata, user-related metadata, and group-related metadata. Hereinafter, one example of such metadata will be described.

Music Track-Related Metadata

The music track-related metadata contains information regarding the music track formed by the multitrack data. A single piece of music track-related metadata is associated with a single piece of multitrack data. Table 1 below illustrates one example of the music track-related metadata.

TABLE 1
Music track-related metadata (song)

| Attribute name | Attribute data |
|---|---|
| song_id | ID_SNG_1 |
| song_name | Song A |
| cover_or_original | Cover |
| mood | Aggressive |
| tempo | 120 |
| duration | 270000 |
| genre | Rock |
| owner_user | ID_USR_1 |
| owner_group | ID_GRP_1 |

<track_composition>

| | |
|---|---|
| track | ID_TRK_1 |
| track | ID_TRK_42 |
| track | ID_TRK_367 |
| track | ID_TRK_456 |
| track | ID_TRK_5943 |
| track | ID_TRK_6642 |
| track | ID_TRK_7987 |

Attribute data with an attribute name “song_id” is identification information on the music track. Attribute data with an attribute name “song_name” is information indicating a music track name. Attribute data with an attribute name “cover_or_original” is information indicating whether the music track is a cover or an original. Attribute data with an attribute name “mood” is information indicating the mood of the music track. Attribute data with an attribute name “tempo” is information indicating the tempo (e.g., BPM: beats per minute) of the music track. Attribute data with an attribute name “duration” is information indicating the length (e.g., milliseconds) of the music track. Attribute data with an attribute name “genre” is information indicating the genre of the music track. Attribute data with an attribute name “owner_user” is information indicating the user as an owner of the music track. Attribute data with an attribute name “owner group” is information indicating the group as the owner of the music track.

Attribute data contained in an attribute data group “track composition” is attribute data regarding the track data forming the music track. Attribute data with an attribute name “track” is information indicating the track data forming the music track, i.e., the track data contained in the multitrack data.

Track-Related Metadata

The track-related metadata contains information regarding the track data. A single piece of track-related metadata is associated with a single piece of track data. Table 2 below illustrates one example of the track-related metadata

TABLE 2
Track-related metadata (track)

| Attribute name | Attribute data |
|---|---|
| track_id | ID_TRK_1 |
| track_name | Track A |
| cover_or_original | Cover |
| instrument | Vocal |
| mode | Aggressive |
| tempo | 120 |
| duration | 270000 |
| genre | Rock |
| owner | ID_USR_1 |

<effect>

| | |
|---|---|
| eq | Bass-boost |
| reverb | Studio |

<object_audio>

| | |
|---|---|
| relative_posistion_x | 400 |
| relative_posistion_y | 350 |
| relative_posistion_z | 0 |
| relative_velocity | 25 |

<songs_structured_by_this>

| | |
|---|---|
| song | ID_SNG_1 |
| song | ID_SNG_567 |
| song | ID_SNG_1054 |
| song | ID_SNG_2064 |
| song | ID_SNG_9876 |

Attribute data with an attribute name “track id” is identification information on the track data. Attribute data with an attribute name “track_name” is information indicating the name of the track data. Attribute data with an attribute name “cover_or_original” is information indicating whether the track data is a cover or an original. Attribute data with an attribute name “instrument” is information indicating which musical instrument (including the vocal) has been used to record the track data. Attribute data with an attribute name “mood” is information indicating the mood of the track data. Attribute data with an attribute name “tempo” is information indicating the tempo of the track data. Attribute data with an attribute name “duration” is information indicating the length (e.g., milliseconds) of the track data. Attribute data with an attribute name “genre” is information indicating the genre of the track data. Attribute data with an attribute name “owner” is information indicating the user as an owner of the track data.

Attribute data contained in an attribute data group “effect” is attribute data regarding the effect applied to the track data. Attribute data with an attribute name “eq” is information indicating the type of equalizer applied to the track data. Attribute data with an attribute name “reverb” is information indicating the type of reverb applied to the track data.

Attribute data contained in an attribute data group “object_audio” is attribute data for implementing stereophony. Attribute data with an attribute name “relative_position_x” is information indicating a stereotactic position (a position relative to a listening point) in an X-axis direction, the stereotactic position being applied to the track data. Attribute data with an attribute name “relative_position_y” is information indicating a stereotactic position in a Y-axis direction, the stereotactic position being applied to the track data. Attribute data with an attribute name “relative_position_z” is information indicating a stereotactic position in a Z-axis direction, the stereotactic position being applied to the track data. Attribute data with an attribute name “relative_velocity” is information indicating a velocity (a velocity relative to the listening point) applied to the track data.

Attribute data in an attribute data group “songs_structured_by_this” is attribute data regarding the music track (the multitrack data) containing the track data as a component, i.e., the music track containing the track data in “track composition.” Attribute data with an attribute name “song” is information indicating the multitrack data containing the track data as the component.

User-Related Metadata

The user-related metadata contains information regarding the user. A single piece of user-related metadata is associated with the single user. Table 3 below illustrates one example of the user-related metadata.

TABLE 3
User-related metadata (user)

| Attribute name | Attribute data |
|---|---|
| user_id | ID_USR_1 |
| user_name | Vocalist_A |
| instrument | Vocal |
| genre | Rock |
| age | 25 |
| gender | male |
| location | Japan |

<owner_tracks>

| | |
|---|---|
| track | ID_TRK_1 |
| track | ID_TRK_10 |
| track | ID_TRK_124 |
| track | ID_TRK_309 |
| track | ID_TRK_502 |

<owner_songs>

| | |
|---|---|
| song | ID_SNG_1 |
| song | ID_SNG_32 |
| song | ID_SNG_6092 |

<affiliation>

| | |
|---|---|
| group | ID_GRP_1 |
| group | ID_GRP_3 |
| group | ID_GRP_54 |

<follow>

| | |
|---|---|
| user | ID_USR_2 |
| user | ID_USR_234 |
| group | ID_GRP_74 |
| group | ID_GRP_568 |

<follower>

| | |
|---|---|
| user | ID_USR_62 |
| user | ID_USR_478 |
| user | ID_USR_526 |
| user | ID_USR_48749 |
| user | ID_USR_64764 |

Attribute data with an attribute name “user_id” is identification information on the user. Attribute data with an attribute name “user_name” is information indicating the name of the user. Attribute data with an attribute name “instrument” is information indicating a musical instrument assigned to the user. Attribute data with an attribute name “genre” is information indicating a user's favorite genre. Attribute data with an attribute name “age” is information indicating the age of the user. Attribute data with an attribute name “gender” is information indicating the gender of the user. Attribute data with an attribute name “location” is information indicating the place of residence of the user.

Attribute data contained in an attribute data group “owner_tracks” is attribute data regarding the track data whose owner is the user. Attribute data with an attribute name “track” is information indicating the track data whose owner is the user.

Attribute data contained in an attribute data group “owner_songs” is attribute data regarding the music track whose owner is the user. Attribute data with an attribute name “song” is information indicating the multitrack data whose owner is the user.

Attribute data contained in an attribute data group “affiliation” is information regarding the group in which the user participates as a member. Attribute data with an attribute name “group” is information indicating the group in which the user participates as the member.

Attribute data contained in an attribute data group “follow” is information regarding the other users or groups followed by the user on the SNS. Attribute data with an attribute name “user” is information indicating the other users followed by the user on the SNS. Attribute data with an attribute name “group” is information indicating the groups followed by the user on the SNS.

Attribute data contained in an attribute data group “follower” is information regarding the other users following the user on the SNS. Attribute data with an attribute name “user” is information indicating the other users following the user on the SNS.

Group-Related Metadata

The group-related metadata contains information regarding the group. A single piece of group-related metadata is associated with the single group. Table 4 below illustrates one example of the group-related metadata.

TABLE 4
Group-related metadata (group)

| Attribute name | Attribute data |
|---|---|
| group_id | ID_GRP_1 |
| group_name | Group A |
| genre | Rock |
| owner | ID_USR_1 |

<owner_songs>

| | |
|---|---|
| song | ID_SNG_1 |
| song | ID_SNG_436 |
| song | ID_SNG_3467 |
| song | ID_SNG_34667 |
| song | ID_SNG_74563 |

<members>

| | |
|---|---|
| user | ID_USR_1 |
| user | ID_USR_43 |
| user | ID_USR_335 |
| user | ID_USR_457 |
| user | ID_USR_734 |
| user | ID_USR_1054 |
| user | ID_USR_3445 |

<follower>

| | |
|---|---|
| user | ID_USR_72 |
| user | ID_USR_677 |
| user | ID_USR_2364 |

Attribute data with an attribute name “group_id” is identification information on the group. Attribute data with an attribute name “group_name” is information indicating the name of the group. Attribute data with an attribute name “genre” is information indicating the genre of the group. Attribute data with an attribute name “owner” is information indicating the user as an owner of the group.

Attribute data contained in an attribute data group “owner_songs” is information regarding the music track whose owner is the group. Attribute data with an attribute name “song” is information indicating the music track whose owner is the group.

Attribute data contained in an attribute data group “members” is information regarding the user as a member forming the group. Attribute data with an attribute name “user” is information indicating the user as the member forming the group.

Attribute data in an attribute data group “follower” is information regarding the user following the group on the SNS. Attribute data with an attribute name “user” is information indicating the user following the group on the SNS.

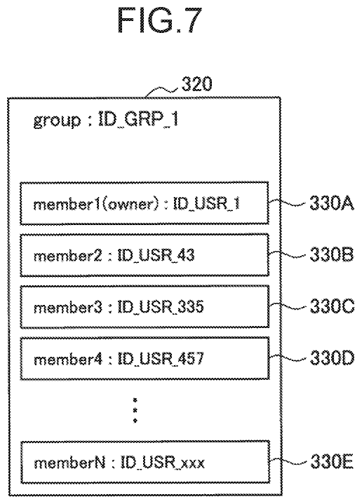

A relationship between the group and the user will be described herein with reference to FIG. 7. FIG. 7 is a diagram illustrating the relationship between the group and the user according to the present embodiment. FIG. 7 illustrates a group 320 to which identification information “ID_GRP_1” is assigned and a user 330 (330A to 330E) included in the group 320. A character string of “ID_USER_” and a number assigned to each piece of user data 330 and coupled to each other is identification information on each piece of user data 330. As illustrated in FIG. 7, the group may include the multiple users. One of the multiple users included in the group is set as an owner playing a role as an administrator of the group.

One example of the metadata has been described above.

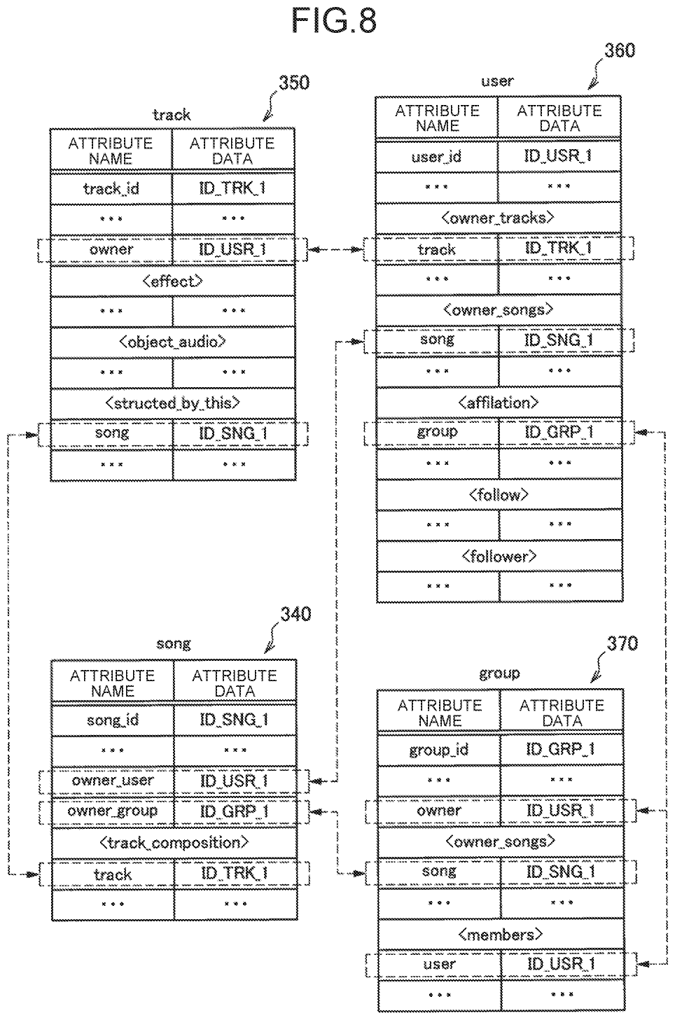

By analyzing such metadata, particularly analyzing the metadata in combination, a relationship among the music track, the track, the user, and the group can be grasped. For example, by analyzing the metadata on a certain track, a music track formed by such a track, a user having produced such a track, and a group to which such a user belongs can be recognized, for example. As one example, one example of a relationship among various types of metadata will be described with reference to FIG. 8.

FIG. 8 is a diagram for describing one example of the relationship among various types of metadata according to the present embodiment. In the example illustrated in FIG. 8, a relationship among music track-related metadata 340 illustrated in Table 1 above, track-related metadata 350 illustrated in Table 2 above, user-related metadata 360 illustrated in Table 3 above, and group-related metadata 370 illustrated in Table 4 above is illustrated. As illustrated in FIG. 8, a relationship between the music track and the track forming the music track is shown with reference to the music track-related metadata 340 and the track-related metadata 350. A relationship between the music track and the user as the owner of the music track is shown with reference to the music track-related metadata 340 and the user-related metadata 360. A relationship between the music track and the group as the owner of the music track is shown with reference to the music track-related metadata 340 and the group-related metadata 370. A relationship between the track and the user as the owner of the track is shown with reference to the track-related metadata 350 and the user-related metadata 360. A relationship between the user and the group as the owner whose member is the user is shown with reference to the user-related metadata 360 and the group-related metadata 370.

Data Format of Metadata

The metadata may be transmitted/received between the apparatuses included in the system 1. For example, the metadata may be transmitted/received among the terminal apparatus 10, the server 20, and the metadata DB 41. Various formats of the metadata upon transmission/reception are conceivable. For example, as illustrated below, the format of the metadata may be an XML format.

<track>

<track_id>1</track_id>
<track_name>Track A</tarack_name>
<cover_or_original>Cover</cover_or_original>
<instrument>Vocal</instrument>
<mood>Aggressive</mood>
<tempo>120</tempo>
<duration>270000</duration>
<genre>Rock</genre>
<owner>ID_USR_1</owner>
<effect effect_type=“Equalizer”>

<effect_name>Bass-boost</effect_name>
<effect_value>20</effect_value>

</effect>
<effect effect_type=“Reverb”>

<effect_name>Studio</effect_name>
<effect_value>40</effect_value>
</effect_type>

</effect>
<object_audio>

<rerative_position_x>4000</rerative_position_x>
<rerative_position_y>3500</rerative_position_y>
<rerative_position_z>500</rerative_postion_z>
<rerative_velocity>25</rerative_velocity>

</object_audio>
<songs_structured_by_this>

<song_id>ID_SING_1</song_id>
<song_id>ID_SING_567</song_id>
<song_id>ID_SING_1054</song_id>
<song_id>ID_SING_2064</song_id>
<song_id>ID_SING_9876</song_id>

</songs_structured_by_this>

</track>

As another alternative, the format of the metadata may be a JSON format as illustrated below.

{

track: {

track_id: “1”,
track_name: “Track A”,
track_part: “xx”,
cover_or_original: “Cover”,
instrument: “Vocal”,
mood: “Aggressive”,
tempo: “120”,
duration: “270000”,
genre: “Rock”,
owner: “ID_USR_1”,
effect: {

{

effect_type: “Equalizer”,
effect_name: “Bass-boost”,
effect_value:“20”

}
{

effect_type: “Reverb”,
effect_name: “Studio”,
effect_value:“40”

}

}
object_audio: {

rerative_position_x: “4000”,
rerative_position_y: “3500”
rerative_position_z: “500”
rerative_velocity: “25”

}
songs_structured_by_this: (

“ID_SING_1”,
“ID_SING_567”,
“ID_SING_1054”,
“ID_SING_2064”,
“ID_SING_9876”

}

}

}

### 3.2. Editing of Multitrack Data

The server 20 (e.g., the DB control unit 220) transmits the multitrack data stored in the contents DB 40 to the terminal apparatus 10 configured to edit the multitrack data. The terminal apparatus 10 (e.g., the editing unit 130) receives the multitrack data from the server 20, and edits the received multitrack data to transmit the edited multitrack data to the server 20. The server 20 receives the edited multitrack data from the terminal apparatus 10, and updates the multitrack data stored in the contents DB 40 by the edited multitrack data. By such a series of processing, the multitrack data downloaded from the server 20 is edited with a data format as the multitrack data being maintained, is uploaded to the server 20, and is overwritten in the contents DB 40. Thus, the data format is still the multitrack data even after editing by the terminal apparatus 10, and therefore, a high degree of freedom in editing can be maintained. For example, the track data added to the multitrack data by the terminal apparatus 10 can be deleted later by the other users. Moreover, the effect applied by the terminal apparatus 10 can be changed later by the other users.

The multitrack data received by the terminal apparatus 10 from the server 20 as described herein contains multiple pieces of track data produced by the different users. That is, in a state in which the multitrack data contains the track data produced (i.e., generated or added) by the different users, the multitrack data is subjected to editing by the terminal apparatus 10. For example, the multitrack data edited (e.g., the track data is newly added) using the terminal apparatus 10 by a certain user is subjected to editing by the terminal apparatuses 10 of the other users. In this manner, the multiple users can collaboratively produce the music track via the network.

The terminal apparatus 10 can add, as editing of the multitrack data, the new track data to the multitrack data independently of multiple pieces of track data contained in the received multitrack data. For example, the terminal apparatus 10 adds the newly-recorded track data to the multitrack data. The newly-added track data is independent of the track data already contained in the multitrack data, and therefore, a high degree of freedom in editing can be also maintained even after editing of the multitrack data.

The terminal apparatus 10 can delete, as editing of the multitrack data, the track data contained in the multitrack data from the multitrack data. For example, the terminal apparatus 10 deletes part or entirety of the track data contained in the received multitrack data. In addition, the terminal apparatus 10 may replace the track data contained in the received multitrack data with the new track data (i.e., deletes the existing track data and adds the new track data). As described above, the track data added to the multitrack data previously can be deleted later, and therefore, the degree of freedom in editing is improved.

The terminal apparatus 10 can change, as editing of the multitrack data, at least any of the sound volume, stereotactic position, and effect of the track data contained in the multitrack data.

For example, the terminal apparatus 10 changes at least any of the sound volume, stereotactic position, and effect of the track data contained in the received multitrack data or the newly-added track data. In this manner, the user can perform a fine mix process for each of multiple pieces of track data contained in the multitrack data.

### 3.3. UI

The terminal apparatus 10 (e.g., the UI control unit 120) generates and outputs an output screen (UI). For example, the terminal apparatus 10 generates and outputs the UI for implementing editing of the multitrack data as described above. There are various UIs generated and output by the terminal apparatus 10. Hereinafter, one example of the UI generated and output by the terminal apparatus 10 will be described.

An SNS screen is a screen for displaying information regarding the SNS provided by the server 20. For example, the SNS screen may contain information regarding the other users relating to the user, such as the other users having preferences similar to that of the user or the other users as friends of the user. The SNS screen may contain information regarding the group relating to the user, such as the group having a preference similar to that of the user, the group to which the user belongs, the group followed by the user, or the group relating to the other users relating to the user. The SNS screen may contain information regarding the music track relating to the user, such as a user's favorite music track, the music track produced and added by the user, or the music tracks produced by the other users relating to the user. The SNS screen may contain information regarding the track relating to the user, such as the user's favorite music track, the track recorded by the user, or the tracks recorded by the other users relating to the user. On the SNS screen, the user can select the music track targeted for reproduction or editing, or can exchange a message with the other users, for example.

A music track screen is a screen for displaying information on the music track. On the music track screen, a music track name, an image, the user involved in music track production, a comment provided to the music track, etc. are displayed. On the music track screen, the user can reproduce the music track, or can provide a message.

An editing screen is the UI for editing the track data into the multitrack data. On the editing screen, the user can add or delete the track data, or can instruct the start of the mix process.

A recording screen is the UI for recording the track data. On the recording screen, e.g., information indicating a recording level, a waveform, time elapsed after the start of recording, and a musical instrument which is being recorded is displayed. On the recording screen, the user can record the track data.

A mixer screen is the UI for performing mixing of the music track based on the multitrack data. On the mixer screen, the track data contained in the multitrack data and the sound volume and stereotactic position of each piece of track data are displayed, for example. On the mixer screen, the user can perform the mix process.

The terminal apparatus 10 outputs these UIs while causing the UIs to transition as necessary. For example, when the music track is selected on the SNS screen, the terminal apparatus 10 causes the screen to transition to the music track screen of such a music track. Subsequently, when the music track displayed on the music track screen is selected as the editing target, the terminal apparatus 10 causes the screen to transition to the editing screen. Next, when track addition is instructed on the editing screen, the terminal apparatus 10 causes the screen to transition to the recording screen, and upon completion of recording, causes the screen to transition to the editing screen. Moreover, when the start of the mix process is instructed on the editing screen, the terminal apparatus 10 causes the screen to transition to the mixer screen, and upon completion of the mix process, causes the screen to transition to the editing screen. Then, when the process on the editing screen ends, the terminal apparatus 10 causes the screen to transition to the music track screen. Note that the UIs and transition between the UIs as described above are merely one example, and the present technique is not limited to such an example.

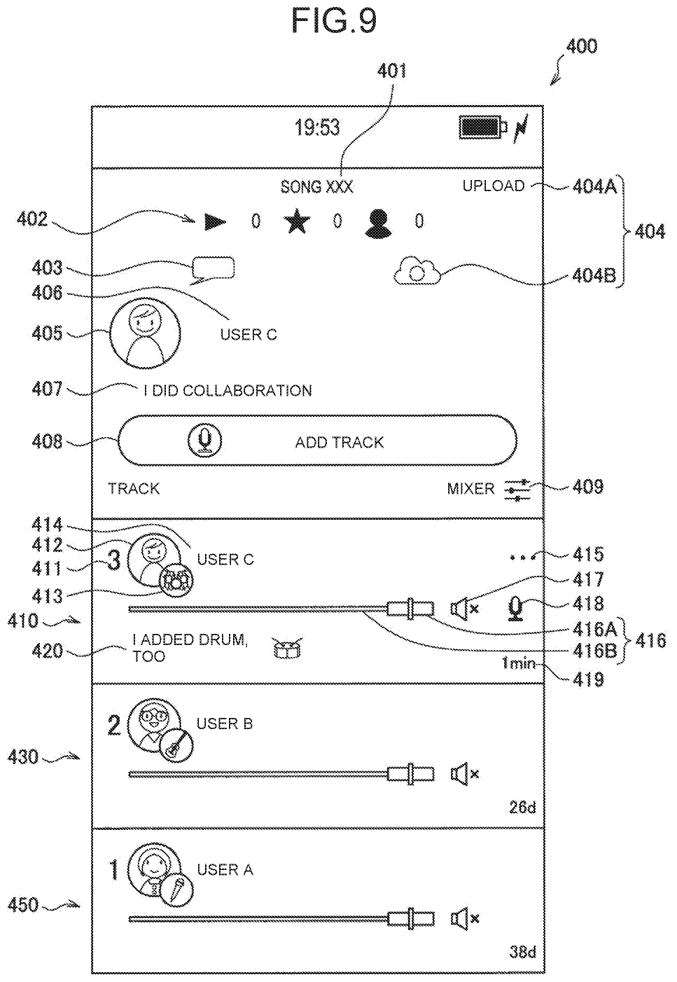

Hereinafter, one example of the above-described UIs will be described with reference to FIGS. 9 to 12. Note that the UI includes one or more UI elements. The UI element may function as an operation unit configured to receive the user operation such as selection or slide, particularly the operation of editing the multitrack data.

FIG. 9 is a view illustrating one example of the UI displayed on the terminal apparatus 10 according to the present embodiment. FIG. 9 illustrates one example of the editing screen. An editing screen 400 illustrated in FIG. 9 includes multiple UI elements. An UI element 401 is the name of the music track targeted for editing. An UI element 402 is information added to the music track targeted for editing on the SNS, the UI element 402 indicating the number of times of reproduction, the number of times of bookmarking, and the number of collaborative users (e.g., the users having performed editing such as addition of the track data) in this order from the left. An UI element 403 is an operation unit configured to receive the operation of providing a comment to the music track targeted for editing. An UI element 404 (404A and 404B) is an operation unit for synchronizing the terminal apparatus 10 and the server 20. Specifically, an UI element 404A is an operation unit configured to receive an instruction for uploading the edited music track to the server 20. When the user selects the UI element 404A, the edited music track is uploaded to the server 20. Moreover, an UI element 404B is an operation unit for receiving an instruction for receiving the latest multitrack data from the server 20. When the user selects the UI element 404B, the latest multitrack data is received from the server 20, and is reflected on the editing screen 400. An UI element 405 is the icon of the user. An UI element 406 is the name of the user. An UI element 407 is a comment provided by the user. An UI element 408 is an operation unit configured to receive the operation of instruction to add the track. When the user selects the UI element 408, the screen transitions to the recording screen. An UI element 409 is an operation unit for receiving the operation of instruction to start the mix process. When the user selects the UI element 409, the screen transitions the mixer screen.

Each of UI elements 410, 430, 450 corresponds to a single track. That is, in the example illustrated in FIG. 9, the music track includes three tracks. The contents of the UI elements 410, 430, 450 are similar to each other, and therefore, the UI element 410 of these UI elements will be described herein in detail.

An UI element 411 is the order of addition of the track to the music track. An UI element 412 is the icon of the user having added the track. An UI element 413 is information indicating which musical instrument (including the vocal) has been recorded in the track, and in the example illustrated in FIG. 9, indicates that the drum has been recorded in the track. An UI element 414 is the name of the user having added the track. An UI element 415 is an operation unit for receiving the operation of changing the setting of the track. When the user selects the UI element 415, a pop-up for changing the setting is displayed. An UI element 416 is an operation unit for receiving the operation of adjusting the sound volume of the track, and has a slider structure including a knob 416A and a bar 416B. The user moves the knob 416A right to left along the bar 416B so that the sound volume can be adjusted. For example, the sound volume decreases as the knob 416A moves to the left of the bar 416B, and increases as the knob 416A moves to the right of the bar 416B. An UI element 417 is an operation unit for receiving the operation of muting the track (changing the sound volume to zero). When the user selects the UI element 417, the track is muted. When the UI element 417 is selected again, muting is canceled. An UI element 418 is an operation unit for receiving the operation of recording the track again. When the user selects the UI element 418, the screen transitions to the recording screen. An UI element 419 is time at which the track is added, and in the example illustrated in FIG. 9, indicates that the track has been added one minute ago. An UI element 420 is a comment (e.g., a text, an emoji, and/or an image) provided to the track.

One example of the editing screen has been described above. Subsequently, one example of the mixer screen will be described.

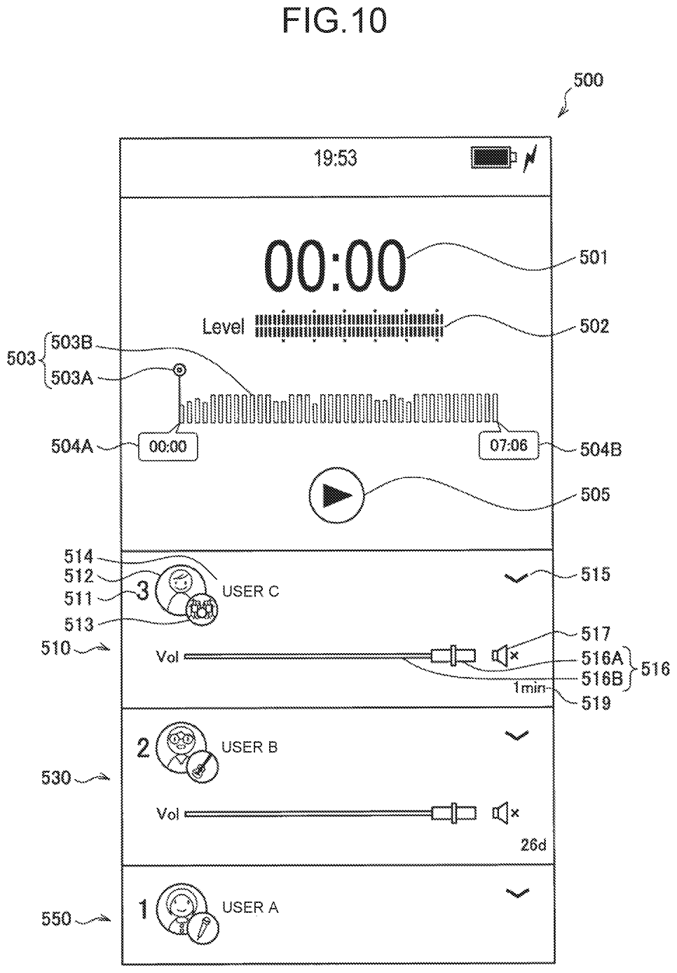

FIG. 10 is a view illustrating one example of the UI displayed on the terminal apparatus 10 according to the present embodiment. FIG. 10 illustrates one example of the mixer screen. A mixer screen 500 illustrated in FIG. 10 includes multiple UI elements. An UI element 501 is time elapsed after reproduction of the music track. An UI element 502 is the indication of the level of the sound volume of the music track which is being reproduced. An UI element 503 is an operation unit for receiving the operation of adjusting the reproduction position of the music track, and has a slider structure including a knob 503A and a bar 503B. The bar 503B is the level of the sound volume, the horizontal axis being time and the vertical axis being each point of time. The knob 503A indicates the reproduction position of the music track. The user moves the knob 503A right to left along the bar 503B so that the reproduction position can be adjusted. For example, the reproduction position moves to the start as the knob 503A moves to the left of the bar 503B, and moves to the end as the knob 503A moves to the right of the bar 503B. An UI element 504A indicates the time of the reproduction position of the music track, and an UI element 504B indicates the time (i.e., the length) of the end of the music track. An UI element 505 is an operation unit configured to receive an instruction for reproduction/stop of the music track. When the user selects the UI element 505, the music track targeted for editing is reproduced from the reproduction position indicated by the bar 503B. When the UI element 505 is selected again, such reproduction is stopped. With this configuration, the user can perform the mix process while checking a mix process result.

Each of UI elements 510, 530, 550 corresponds to a single track. That is, in the example illustrated in FIG. 10, the music track includes three tracks. The UI element 510 corresponds to a track added by a user C, the UI element 530 corresponds to a track added by a user B, and the UI element 550 corresponds to a track added by a user A. The contents of the UI elements 510, 530, 550 are similar to each other, and therefore, the UI element 510 of these UI elements will be described herein in detail.

An UI element 511 is the order of addition of the track to the music track. An UI element 512 is the icon of the user having added the track. An UI element 513 is information indicating which musical instrument (including the vocal) has been recorded in the track, and in the example illustrated in FIG. 10, indicates that the drum has been recorded in the track. An UI element 514 is the name of the user having added the track. An UI element 515 is an operation unit for receiving an UI element displaying instruction for setting the effect to be applied to the track. When the user selects the UI element 515, an UI element for setting the effect to be applied to the track is displayed. An UI element 516 is an operation unit for receiving the operation of adjusting the sound volume of the track. The UI element 516 has a slider structure including a knob 516A and a bar 516B. The user moves the knob 516A right to left along the bar 516B so that the sound volume can be adjusted. For example, the sound volume decreases as the knob 516A moves to the left of the bar 516B, and increases as the knob 516A moves to the right of the bar 516B. An UI element 517 is an operation unit for receiving the operation of muting the track (changing the sound volume to zero). When the user selects the UI element 517, the track is muted. When the UI element 517 is selected again, muting is canceled. An UI element 519 is time at which the track is added, and in the example illustrated in FIG. 10, indicates that the track has been added one minute ago.

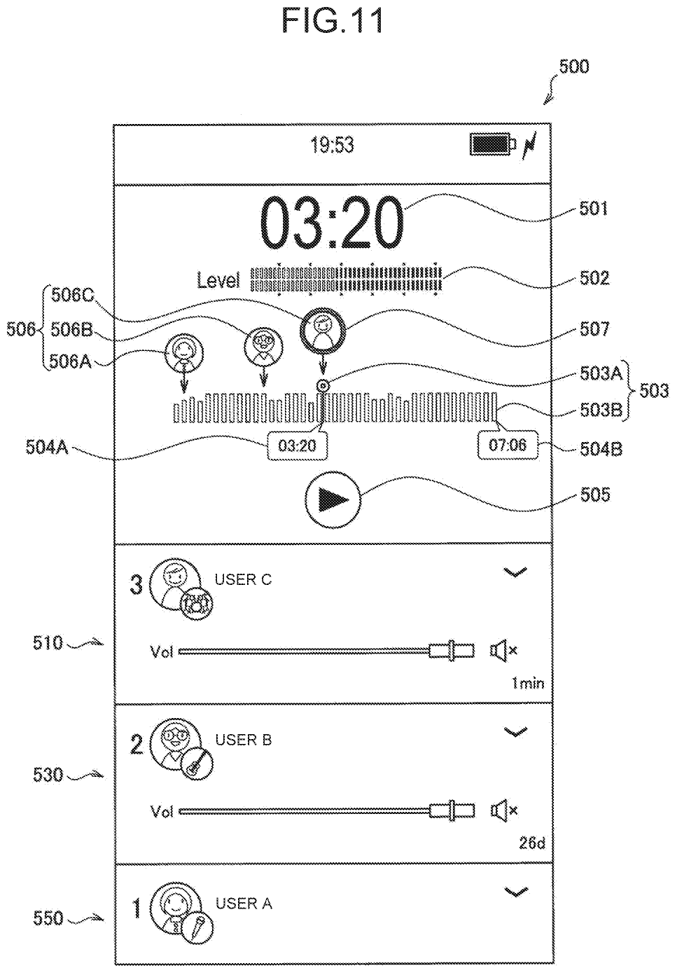

Adjustment of the reproduction position of the music track by the UI element 503 as described herein may be performed in association with the user having added the track. Such an example will be described with reference to FIG. 11. FIG. 11 is a view illustrating one example of the UI displayed on the terminal apparatus 10 according to the present embodiment. On the mixer screen 500 illustrated in FIG. 11, an UI element 506 is added to above the UI element 503. The UI element 506 is information indicating the user having added the track and an arrangement position of such a track in the music track. An UI element 506A is the icon of the user A having added the track corresponding to the UI element 550. An UI element 506B is the icon of the user B having added the track corresponding to the UI element 530. An UI element 506C is the icon of the user C having added the track corresponding to the UI element 510. According to a relationship between the UI element 506 and the bar 503B, the track added by the user A is arranged closer to the beginning of the music track, the track added by the user B is arranged after such a track, and the track added by the user C is arranged further after such a track.

The UI element 506 is also an operation unit for receiving the operation of adjusting the reproduction position of the music track. The user selects the UI element 506 so that the music track can be reproduced from a position corresponding to the arrangement position of the track corresponding to the selected UI element 506. For example, in the example illustrated in FIG. 11, an example where the UI element 506C has been selected is illustrated. An UI element 507 indicates that the UI element 506C has been selected. Then, the music track is reproduced from three minutes and 20 seconds as the reproduction position corresponding to the selected UI element 506C. Thus, the indication of the time of the UI element 501 and an UI element 504 is three minutes and 20 seconds.

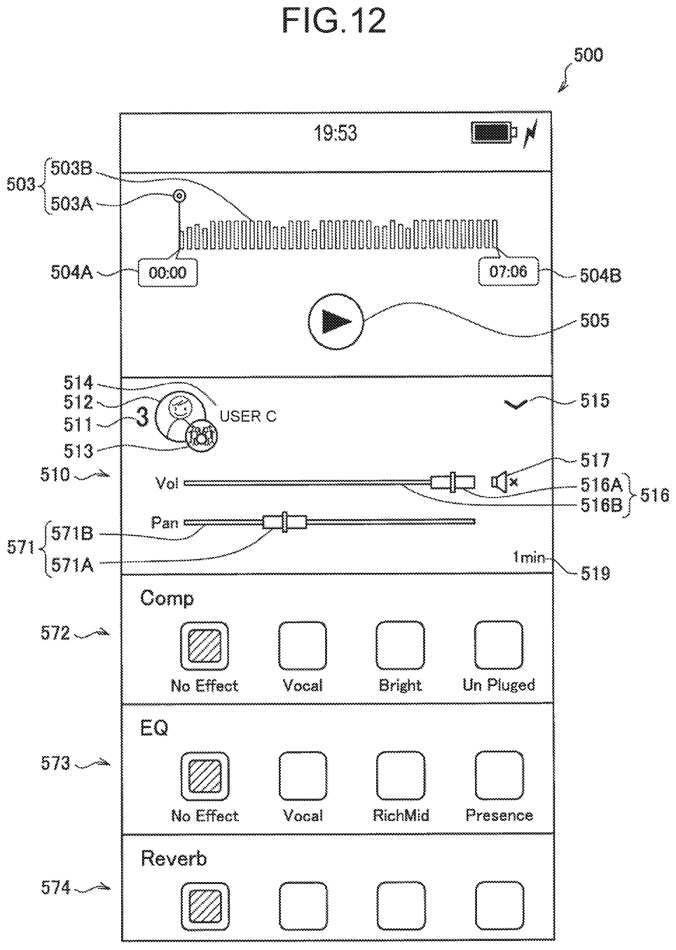

FIG. 12 is a view illustrating one example of the UI displayed on the terminal apparatus 10 according to the present embodiment. FIG. 12 illustrates one example of the mixer screen. The mixer screen 500 illustrated in FIG. 12 is a screen displayed in a case where the UI element 515 has been selected on the mixer screen 500 illustrated in FIG. 10, and is a screen including an UI element for setting the effect to be applied to the track corresponding to the UI element 510. On the mixer screen 500 illustrated in FIG. 12, some UI elements on the mixer screen 500 illustrated in FIG. 10 are not displayed, and the UI element for setting the effect to be applied to the track is newly displayed. Hereinafter, the newly-displayed UI element will be described.

An UI element 571 is an operation unit for receiving the operation of adjusting the stereotactic position of the track, and has a slider structure including a knob 571A and a bar 571B. The user moves the knob 571A right to left along the bar 571B so that the stereotactic position can be adjusted. For example, the stereotactic position moves to the left as the knob 571A moves to the left of the bar 571B, and moves to the right as the knob 571A moves to the right of the bar 571B.

An UI element 572 is an operation unit for selecting whether or not a compressor is to be applied to the track and selecting the type of compressor to be applied. The UI element 572 includes multiple radio buttons, and the user selects any of the radio buttons so that such selection can be performed. In the example illustrated in FIG. 11, the radio button for not applying the compressor to the track has been selected.

An UI element 573 is an operation unit for selecting whether or not the equalizer is to be applied to the track and selecting the type of equalizer to be applied. The UI element 573 includes multiple radio buttons, and the user selects any of the radio buttons so that such selection can be performed. In the example illustrated in FIG. 11, the radio button for not applying the equalizer to the track has been selected.

An UI element 574 is an operation unit for selecting whether or not the reverb is to be applied to the track and selecting the type of reverb to be applied. The UI element 574 includes multiple radio buttons, and the user selects any of the radio buttons so that such selection can be performed. In the example illustrated in FIG. 11, the radio button for not applying the reverb to the track has been selected.

One example of the mixer screen has been described above. Hereinafter, the characteristics of the UIs described with reference to the above-described examples will be described in detail.

The UI for editing the multitrack data may contain, for each of multiple pieces of track data contained in the multitrack data, the identification information on the user having produced (i.e., generated or added) such track data. For example, the editing screen 400 illustrated in FIG. 9 includes the UI elements 410, 430, UI element 450 for each track, and these elements include the UI elements (the UI element 412 and the UI element 413) indicating the icon and name of the user having produced the track data. The mixer screen 500 illustrated in FIG. 10 includes the UI elements 510, 530, 550 for each track, and these elements include the UI elements (the UI element 512 and the UI element 513) indicating the icon and name of the user having produced the track data. As described above, the identification information on the user having produced the track data is displayed on the UI for editing the multitrack data, and therefore, the user can recognize, at a glance, which user is involved in music track production.

The UI for editing the multitrack data may contain, for each of multiple pieces of track data contained in the multitrack data, the information indicating the time at which such track data is produced. For example, the editing screen 400 illustrated in FIG. 9 includes the UI elements 410, 430, 450 for each track, and these elements include the UI element (the UI element 419) indicating the time at which the track data is produced. Moreover, the mixer screen 500 illustrated in FIG. 10 includes the UI elements 510, 530, 550 for each track, and these elements include the UI element (the UI element 519) indicating the time at which the track data is produced. As described above, the time at which the track data is produced is displayed on the UI for editing the multitrack data, and therefore, the user can recognize, at a glance, temporal transition of conjoint operation by multiple users.

The UI for editing the multitrack data may contain, for each of multiple pieces of track data contained in the multitrack data, the comment from the user having produced such track data. For example, the editing screen 400 illustrated in FIG. 9 includes the UI elements 410, 430, 450 for each track, and these elements include the UI element (the UI element 420) indicating the comment added by the user having produced the track data. As described above, the UI for editing the multitrack data contains the comment from the user having produced the track data. Thus, the user can promote communication among the users, and can promote conjoint operation.

The UI for editing the multitrack data may include an operation unit (equivalent to a first operation unit) configured to receive the editing operation of instruction to add the new track data to the multitrack data. For example, the editing screen 400 illustrated in FIG. 9 includes the UI element 408 as the operation unit configured to receive the operation of instruction to add the track. When the user selects the UI element 408, transition to the recording screen is made, and the track data based on a recording result is added to the multitrack data. As described above, the UI for editing the multitrack data includes the UI element configured to receive the editing operation of instruction to add the new track data to the multitrack data, and therefore, the user can easily add the track to the music track.

The UI for editing the multitrack data may include an operation unit (equivalent to a second operation unit) configured to receive the operation of editing the sound volume of each piece of track data. For example, the editing screen 400 illustrated in FIG. 9 includes the UI element 416 as the operation unit for receiving the operation of adjusting the sound volume of the track and the UI element 417 as the operation unit for receiving the operation of the muting the track. Moreover, the mixer screen 500 illustrated in FIGS. 10 and 12 includes the UI element 516 as the operation unit for receiving the operation of adjusting the sound volume of the track and the UI element 517 as the operation unit for receiving the operation of muting the track. With this configuration, the user can change, according to one's preference, the sound volume of each of the multiple tracks contained in the music track.

The UI for editing the multitrack data may include an operation unit (equivalent to a third operation unit) configured to receive the operation of editing the stereotactic position of each piece of track data. For example, the mixer screen 500 illustrated in FIG. 12 includes the UI element 571 as the operation unit for receiving the operation of adjusting the stereotactic position of the track. With this configuration, the user can change, according to one's preference, the stereotactic position of each of the multiple tracks contained in the music track.

The UI for editing the multitrack data may include an operation unit (equivalent to a fourth operation unit) configured to receive the operation of editing the effect of each piece of track data. For example, the mixer screen 500 illustrated in FIG. 12 includes the UI element 572, the UI element 573, and the UI element 574 as the operation units configured to receive the editing operation regarding the compressor, the equalizer, and the reverb. With this configuration, the user can apply one's favorite effect to each of the multiple tracks contained in the music track.

The UI for editing the multitrack data may contain, for each of multiple pieces of track data contained in the multitrack data, information on an association between information indicating the arrangement position of the track data in the music track formed by the multitrack data and the identification information on the user having produced such track data. For example, the mixer screen 500 illustrated in FIG. 11 includes the UI element 506 configured to associate the arrangement position of each of the multiple tracks contained in the music track with the icon of the user having produced such a track. With this configuration, the user can recognize, at a glance, the arrangement position of each of the multiple tracks contained in the music track and the user having produced such a track.

In a case where the user identification information has been selected on the UI for editing the multitrack data, the terminal apparatus 10 can reproduce the music track formed by the multitrack data from a position corresponding to the arrangement position of the track data produced by the selected user. For example, on the mixer screen 500 illustrated in FIG. 11, when the UI element 506 is selected, the terminal apparatus 10 reproduces the music track from a position corresponding to the arrangement position of the track corresponding to the selected UI element 506. The position corresponding to the arrangement position of the track as described herein is, for example, the same position (i.e., the same time) as the arrangement position of the track or a position (i.e., time before the arrangement position) before the arrangement position of the track. With this configuration, when adjusting the reproduction position of the music track, the user can seek the reproduction position by means of the track arrangement position as a guide. For example, the music track can be reproduced from the arrangement position of the track produced by a favorite user.

### 3.4. Editing Support

The server 20 (e.g., the editing support unit 210) performs, based on the information stored in the contents DB 40 or the metadata DB 41, the processing of supporting editing of the music track in the terminal apparatus 10.

Searching

The server 20 searches the track data from the contents DB 40. For example, the server 20 searches the track data based on the metadata stored in the metadata DB 41. As described above, the track data is categorized from various perspectives, and the attribute data for each category is provided as the metadata. Using such metadata, the server 20 can search the track data from enormous tracks accumulated in the contents DB 40.

The track data accumulated in the contents DB 40 as described herein can form the music track in combination with other pieces of track data, and therefore, can be taken as a music resource (piece) for music track production. The user causes the server 20 to search the track data necessary for music track production, and therefore, can easily obtain the necessary track. Accordingly, convenience in music track production is improved.

Matching

The server 20 may perform matching between first track data contained in first multitrack data and second track data contained in second multitrack data. The server 20 performs matching based on metadata regarding the first track data and the second track data. For example, based on at least any of meta information on the track data, meta information on the multitrack data containing the track data, meta information on the user having produced the track data, and meta information on the group as the owner of the multitrack data containing the track data, the server 20 performs matching between the pieces of track data. With this configuration, the server 20 can perform matching between compatible tracks (having a high compatibility coefficient calculated according to a predetermined criterion).

The compatible tracks described herein are, for example, the tracks whose associated meta information is coincident with or similar to each other or the tracks containing the meta information having a high frequency of co-occurrence among the multiple tracks contained in the single piece of multitrack data. For example, the server 20 performs matching between the tracks similar to each other in atmosphere, or performs matching between the tracks produced by users having similar music preferences.

As described above, the server 20 can easily perform matching between the tracks. Thus, the tracks accumulated in the contents DB 40 can be, as enormous music resources (pieces), utilized by the music track producer, and efficiency enhancement and diversity expansion in music track production can be induced. Diversity expansion in music track production as described herein indicates that the user can produce a variety of arrangement versions, can expand a music track range which can be produced, and can discover an unknown music track genre, for example.

The server 20 may perform matching between a first user having produced the first track data contained in the first multitrack data and a second user having produced the second track data contained in the second multitrack data. The server 20 performs matching based on metadata regarding the first user and the second user. The track described herein can be assumed as one of the music resources as a source for the music track on one side. However, on the other side, the track also has an aspect as a resource for expressing the characteristics of the user having produced the track. Thus, the users having produced the compatible tracks can be assumed as compatible with each other in music track production. For this reason, after matching between the tracks as described above, the server 20 links, for example, the track and the track producer to perform matching between compatible producers.

The compatible producers (users) described herein are, for example, the users whose associated meta information is coincident with or similar to each other or the users corresponding to the meta information having a high frequency of co-occurrence among the multiple users belonging to the group for collaboratively producing the music track. For example, the server 20 performs matching between the users preferring similar atmosphere, or performs matching between the users showing the tendency of a high probability of collaboration.

As described above, the server 20 can easily perform matching between the music track producers. Consequently, the server 20 can produce a new connection between the producers without the need for active operation by the producers. The music track producer can produce the music track based on the connection with the new other music track producers, and therefore, efficiency enhancement and diversity expansion in music track production can be further induced.

The server 20 may perform matching between the first user and the second user based on a previous editing history of the first user and/or the second user. The previous editing history is, for example, the track data previously added to the multitrack data, the deleted track data, and the effect applied to the track data. For example, the server 20 performs matching between the users showing a specific tendency in the mix process (e.g., showing the tendency of applying a certain effect to a certain genre of track data). On one side, it can be assumed that the editing history described herein expresses the characteristics of the user having performed editing. Thus, the server 20 performs matching based on the editing history such that matching between the compatible producers is allowed.

As another alternative, matching between the tracks or the users may be performed based on the compatibility of the recording equipment 30 used for production of the track data or used by the user. The compatibility of the recording equipment 30 is, for example, the compatibility of the attribute of the recording equipment 30 such as the type, manufacturer, or model of musical instrument or sound source equipment to be used. For example, it is determined that the tracks or users in such a relationship that the attributes of the recording equipment 30 are coincident with, similar to, or complementary with each other are compatible with each other. As another alternative, the compatibility coefficient of the recording equipment 30 may be calculated based on a matching result history according to other criteria. For example, the recording equipment 30 used for track data production for the tracks determined as compatible according to the other criteria is determined as compatible.

The server 20 may transmit information indicating the above-described matching result to the terminal apparatus 10. For example, the server 20 transmits the track matched with the track produced by the user of the terminal apparatus 10 to the terminal apparatus 10, or transmits information indicating the other users matched with the user of the terminal apparatus 10 to the terminal apparatus 10. With this configuration, efficiency enhancement and diversity expansion in music track production can be promoted.

Call-Out of Track Data

The server 20 may mediate call-out of the track data. The terminal apparatus 10 requests the server 20 to call out the track data to be added to the multitrack data. The server 20 requests the other users who can produce the called-out track data to produce such track data. At this point, the server 20 may perform matching between the users as described above, and may make a request to the other users compatible with the user using the terminal apparatus 10 as a call-out source. Then, the server 20 transmits, to the terminal apparatus 10 as the call-out source, the track data produced by the other users according to the call-out. As another alternative, the server 20 may perform matching between the tracks as described above, and may search the track data compatible with the track data contained in the multitrack data from the contents DB 40 and may transmit such track data to the terminal apparatus 10.

As described above, by the call-out of the track data, the other users can make up for the track data in music track production by the user. Thus, convenience in music track production in the terminal apparatus 10 is improved.

Automatic Production of Remix Music Track

The server 20 may generate the multitrack data by combining multiple pieces of track data. That is, the server 20 may automatically produce the music track by combining the existing tracks. For example, the server 20 combines the multiple tracks which are the compatible tracks matched by matching between the tracks as described above and which are the same as each other in the music track name and are different from each other in the musical instrument, thereby producing the music track. In this manner, the new music track (i.e., remix) obtained by combination of the existing tracks can be automatically produced.

### 3.5. Flow of Processing

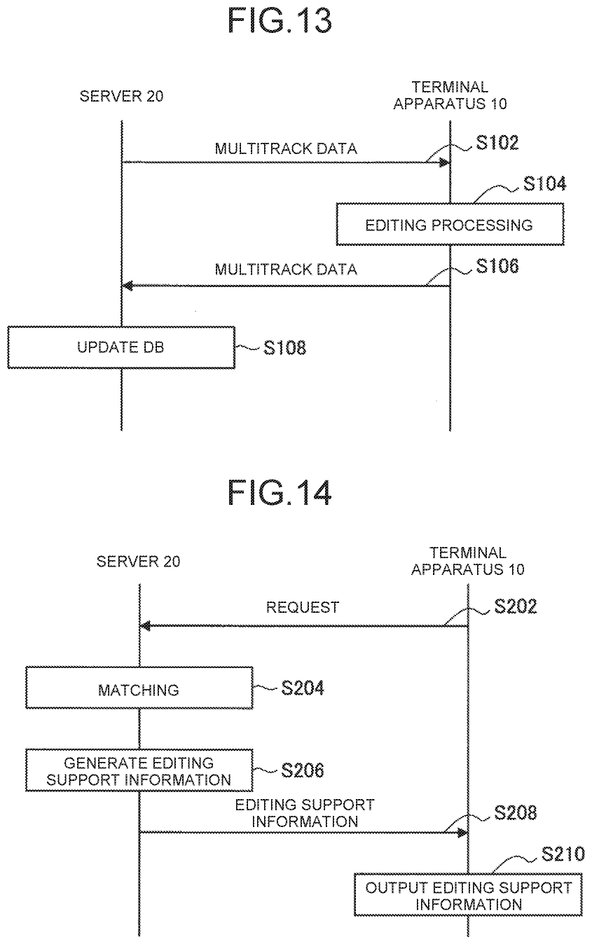

Hereinafter, one example of the flow of processing executed in the system 1 will be described with reference to FIGS. 13 and 14.

Music Track Production Processing

FIG. 13 is a sequence diagram illustrating one example of the flow of music track production processing executed in the system 1 according to the present embodiment. The terminal apparatus 10 and the server 20 are involved in the present sequence.

As illustrated in FIG. 13, the server 20 first transmits the multitrack data to the terminal apparatus 10 (Step S102). For example, the server 20 transmits the multitrack data specified as the editing target by the user to the terminal apparatus 10. Subsequently, the terminal apparatus 10 performs the editing processing based on the user operation (Step S104). For example, the terminal apparatus 10 performs addition of the track data to the multitrack data or deletion of the track data to the multitrack data and application of the effect to the multitrack data. Next, the terminal apparatus 10 transmits the edited multitrack data to the server 20 (Step S106). Then, the server 20 stores the received edited multitrack data in the contents DB 40, thereby updating the DB (Step S108).

Editing Support Processing

FIG. 14 is a sequence diagram illustrating one example of the flow of editing support processing executed in the system 1 according to the present embodiment. The terminal apparatus 10 and the server 20 are involved in the present sequence.

As illustrated in FIG. 14, the terminal apparatus 10 first transmits a request to the server 20 (Step S202). The request described herein is, for example, a matching request, a request for calling out the track data, or a request for producing the music track remix. Subsequently, the server 20 performs matching according to the request (Step S204), and based on a matching result, generates editing support information (Step S206). For example, in a case where the request is the matching request, the server 20 performs matching for the other users or tracks compatible with the user as a request source or the track produced by such a user, thereby generating the editing support information indicating the matching result. For example, in a case where the request is the call-out of the track data, the server 20 requests the other users compatible with the user as the request source to produce the track data, and as the editing support information, generates the track data produced by the other users. For example, in a case where the request is the request for producing the music track remix, the server 20 performs matching between the tracks stored in the contents DB 40 to combine these tracks, thereby generating the new music track remix as the editing support information. Then, the server 20 transmits the generated editing support information to the terminal apparatus 10 (Step S208), and the editing support information is output in the terminal apparatus 10 (Step S210).

### 4. SUMMARY

One embodiment of the present disclosure has been described above in detail with reference to FIGS. 1 to 14. As described above, the terminal apparatus 10 according to the present embodiment receives, from the server 20, the multitrack data containing multiple pieces of track data generated by the different users, edits the multitrack data, and transmits the edited multitrack data. In this manner, the multitrack data downloaded from the server 20 is edited with the data format as the multitrack data being maintained, and is uploaded to the server 20. Thus, a high degree of freedom in editing can be maintained even after editing by the terminal apparatus 10. Consequently, the multiple users can collaboratively produce the music track via the network while holding a high degree of freedom.

The preferred embodiment of the present disclosure has been described above in detail with reference to the attached drawings, but the technical scope of the present disclosure is not limited to such an example. It is obvious that those with common knowledge in the technical field of the present disclosure can arrive at various changes or modifications within the scope of the technical idea described in the claims, and needless to say, it is understood that these changes and modifications also belong to the technical scope of the present disclosure.

Note that a series of processing by each apparatus described in the present specification may be implemented using any of software, hardware, and a combination thereof. Programs forming the software are, for example, stored in advance in storage media (non-transitory media) provided inside or outside each apparatus. Moreover, each program is, for example, read by a RAM in execution by a computer, and is executed by a processor such as a CPU.

Moreover, the processing described using the flowcharts and the sequence diagrams in the present specification is not necessarily executed in the described order. Some processing steps may be executed in parallel. Alternatively, an additional processing step may be employed, or some processing steps may be omitted.

Further, advantageous effects described in the present specification are merely explanation or exemplification, and are not limited. That is, the technique according to the present disclosure can provide other advantageous effects obvious to those skilled in the art from description of the present specification in addition to or instead of the above-described advantageous effects.

Note that the following configurations also belong to the technical scope of the present disclosure.

(1)

An information processing apparatus comprising:

a control unit configured to
receive multitrack data containing multiple pieces of track data generated by different users,
edit the multitrack data, and
transmit the edited multitrack data.
   (2)

The information processing apparatus according to (1), wherein

the control unit generates an output screen indicating the multitrack data, and

the output screen includes, for each of the multiple pieces of track data contained in the multitrack data, identification information on the users having generated the track data.

(3)

The information processing apparatus according to (2), wherein

the output screen includes, for each of the multiple pieces of track data contained in the multitrack data, information indicating time at which the track data has been generated.

(4)

The information processing apparatus according to (2) or (3), wherein

the output screen includes, for each of the multiple pieces of track data contained in the multitrack data, a comment from each user having generated the track data.

(5)

The information processing apparatus according to any one of (2) to (4), wherein

the output screen includes a first operation unit configured to receive an editing operation of instruction to add new track data to the multitrack data.

(6)

The information processing apparatus according to any one of (2) to (5), wherein

the output screen includes at least any of a second operation unit configured to receive an operation of editing a sound volume of each piece of track data, a third operation unit configured to receive an operation of editing a stereotactic of each piece of track data, and a fourth operation unit configured to receive an operation of editing an effect of each piece of track data.

(7)

The information processing apparatus according to any one of (2) to (6), wherein

the output screen includes, for each of the multiple pieces of track data contained in the multitrack data, information on an association between information indicating an arrangement position of the track data in a music track formed by the multitrack data and the identification information on the user having generated the track data.

(8)

The information processing apparatus according to (7), wherein

in a case where the user identification information has been selected on the output screen, the control unit reproduces the music track formed by the multitrack data from a position corresponding to the arrangement position of the track data generated by the selected user.

(9)

The information processing apparatus according to any one of (1) to (8), wherein

the control unit adds, as editing of the multitrack data, new track data to the multitrack data independently of the multiple pieces of track data contained in the received multitrack data.

(10)

The information processing apparatus according to any one of (1) to (9), wherein

the control unit deletes, as editing of the multitrack data, the track data contained in the multitrack data from the multitrack data.

(11)

The information processing apparatus according to any one of (1) to (10), wherein

the control unit changes, as editing of the multitrack data, at least any of a sound volume, a stereotactic position, and an effect of the track data contained in the multitrack data.

(12)

An information processing apparatus comprising:

a control unit configured to
transmit multitrack data containing multiple pieces of track data generated by different users and stored in a storage apparatus to a terminal apparatus configured to edit the multitrack data,
receive the edited multitrack data from the terminal apparatus, and
update the multitrack data stored in the storage apparatus by the edited multitrack data.
   (13)

The information processing apparatus according to (12), wherein

the control unit performs matching between first track data contained in first multitrack data and second track data contained in second multitrack data.

(14)

The information processing apparatus according to (13), wherein

the control unit performs matching between a first user having generated the first track data contained in the first multitrack data and a second user having generated the second track data contained in the second multitrack data.

(15)

The information processing apparatus according to (14), wherein

the control unit performs the matching based on a previous editing history by the first user or the second user.

(16)

The information processing apparatus according to any one of (13) to (15), wherein

the control unit transmits information indicating a matching result to the terminal apparatus.

(17)

An information processing method executed by a processor, comprising:

receiving multitrack data containing multiple pieces of track data generated by different users;

editing the multitrack data; and

transmitting the edited multitrack data.

(18)

A program for causing a computer to function as a control unit configured to
receive multitrack data containing multiple pieces of track data generated by different users,
edit the multitrack data, and transmit the edited multitrack data.

### REFERENCE SIGNS LIST

1 SYSTEM
10 TERMINAL APPARATUS
11 INPUT/OUTPUT UNIT
12 OPERATION INTERFACE
13 DISPLAY UNIT
14 AUDIO SIGNAL INPUT/OUTPUT INTERFACE
15 NETWORK INTERFACE
16 BUS
17 STORAGE UNIT
18 CONTROL UNIT
110 AUDIO SIGNAL ACQUISITION UNIT
120 UI CONTROL UNIT
130 EDITING UNIT
20 SERVER
21 INPUT/OUTPUT UNIT
22 NETWORK INTERFACE
23 BUS
24 STORAGE UNIT
25 CONTROL UNIT
210 EDITING SUPPORT UNIT
220 DB CONTROL UNIT
30 RECORDING EQUIPMENT
40 CONTENTS DB
41 METADATA DB
50 NETWORK

1. An information processing apparatus comprising:
a control unit configured to
receive multitrack data containing multiple pieces of track data generated by different users,
edit the multitrack data, and
transmit the edited multitrack data.

2. The information processing apparatus according to claim 1, wherein
the control unit generates an output screen indicating the multitrack data, and
the output screen includes, for each of the multiple pieces of track data contained in the multitrack data, identification information on the users having generated the track data.

3. The information processing apparatus according to claim 2, wherein
the output screen includes, for each of the multiple pieces of track data contained in the multitrack data, information indicating time at which the track data has been generated.

4. The information processing apparatus according to claim 2, wherein
the output screen includes, for each of the multiple pieces of track data contained in the multitrack data, a comment from each user having generated the track data.

5. The information processing apparatus according to claim 2, wherein
the output screen includes a first operation unit configured to receive an editing operation of instruction to add new track data to the multitrack data.

6. The information processing apparatus according to claim 2, wherein
the output screen includes at least any of a second operation unit configured to receive an operation of editing a sound volume of each piece of track data, a third operation unit configured to receive an operation of editing a stereotactic of each piece of track data, and a fourth operation unit configured to receive an operation of editing an effect of each piece of track data.

7. The information processing apparatus according to claim 2, wherein
the output screen includes, for each of the multiple pieces of track data contained in the multitrack data, information on an association between information indicating an arrangement position of the track data in a music track formed by the multitrack data and the identification information on the user having generated the track data.

8. The information processing apparatus according to claim 7, wherein
in a case where the user identification information has been selected on the output screen, the control unit reproduces the music track formed by the multitrack data from a position corresponding to the arrangement position of the track data generated by the selected user.

9. The information processing apparatus according to claim 1, wherein
the control unit adds, as editing of the multitrack data, new track data to the multitrack data independently of the multiple pieces of track data contained in the received multitrack data.

10. The information processing apparatus according to claim 1, wherein
the control unit deletes, as editing of the multitrack data, the track data contained in the multitrack data from the multitrack data.

11. The information processing apparatus according to claim 1, wherein
the control unit changes, as editing of the multitrack data, at least any of a sound volume, a stereotactic position, and an effect of the track data contained in the multitrack data.

12. An information processing apparatus comprising:
a control unit configured to
transmit multitrack data containing multiple pieces of track data generated by different users and stored in a storage apparatus to a terminal apparatus configured to edit the multitrack data,
receive the edited multitrack data from the terminal apparatus, and
update the multitrack data stored in the storage apparatus by the edited multitrack data.

13. The information processing apparatus according to claim 12, wherein
the control unit performs matching between first track data contained in first multitrack data and second track data contained in second multitrack data.

14. The information processing apparatus according to claim 13, wherein
the control unit performs matching between a first user having generated the first track data contained in the first multitrack data and a second user having generated the second track data contained in the second multitrack data.

15. The information processing apparatus according to claim 14, wherein
the control unit performs the matching based on a previous editing history by the first user or the second user.

16. The information processing apparatus according to claim 13, wherein
the control unit transmits information indicating a matching result to the terminal apparatus.

17. An information processing method executed by a processor, comprising:
receiving multitrack data containing multiple pieces of track data generated by different users;
editing the multitrack data; and
transmitting the edited multitrack data.

18. A program for causing a computer to function as a control unit configured to
receive multitrack data containing multiple pieces of track data generated by different users,
edit the multitrack data, and
transmit the edited multitrack data.
